(19) United States
(12) Patent Application Publication
(10) Pub. No.: US 2025/0044134 A1
(43) Pub. Date: Feb. 6, 2025

(54) Area Velocity Sleeve Sensor

(71) Applicant: ADS LLC, Huntsville, AL (US)

(72) Inventor: James S. Schutzbach, Madison, AL (US)

(21) Appl. No.: 18/786,472

(22) Filed: Jul. 27, 2024

Related U.S. Application Data
(60) Provisional application No. 63/530,119, filed on Aug. 1, 2023.

(51) Int. Cl. G01F 1/66; G01F 1/663

(52) U.S. Cl. CPC G01F 1/662; G01F 1/663

(57) ABSTRACT

A flow sensor system that provides a measurement of the liquid flow in a horizontal pipe. The system comprises a mounting having a thin substantially cylindrical body forming less than 360 degrees of the circular dimension. The body includes elastic material and is formed to be of greater diameter than the pipe inside diameter, when the system is outside the pipe and free of constraint. Upon installation, the mounting is compressed to be easily inserted into the pipe and then released to expand to fit the pipe inside surface and press against the pipe inside surface to maintain position during operation. The system may include ultrasonic flow rate sensors, depth sensors, tilt and roll sensors, temperature sensors and/or other sensors as needed. The system may include cable interconnect for power and communication with a base system.

### RELATED APPLICATIONS

This application claims the benefit under 35 USC 119 (e) of provisional application Serial No. 63/530,119, titled “Area Velocity Sleeve Sensor”, filed Aug. 1, 2023 by Schutzbach.

All of the above listed U.S. Patent and Patent Applications are hereby incorporated herein by reference in their entirety.

### TECHNICAL FIELD

The present invention pertains generally to the field of level, velocity, and flow sensing of liquids, more particularly to liquid sensing in pipes, containers, and spaces, with particular benefits to horizontal pipe structures.

### BACKGROUND

The benefits of monitoring wastewater and storm sewers in cities and broader municipalities is becoming well known and documented. Thus, there is a need for increased monitoring of sewers in existing and expanding municipalities in order to plan and efficiently utilize cities limited resources.

Level, velocity, and flow monitoring in pipes and sewers offers numerous challenges including varied structures, clutter, condensing and corrosive atmospheres. In particular ultrasonic sensing in pipes is complicated by cramped spaces for installation and service and the need to make measurement without interrupting flow or snagging debris.

Thus, there is a need for low cost, accurate, remote water level, velocity, and flow monitoring in unattended locations to provide data for city planners and real time data for problem and fault detection.

### BRIEF DESCRIPTION

The present disclosure pertains generally to a flow sensor system that provides a measurement of the liquid flow in a horizontal pipe. The system comprises a mounting having a thin substantially cylindrical body forming less than 360 degrees of the circular dimension. The body includes elastic material and is formed to be of greater diameter than the designed pipe inside diameter, when outside the pipe and free of constraint. Upon installation, the mounting is compressed to be easily inserted into the pipe and then released to expand to fit the pipe inside surface and press against the pipe inside surface to maintain position during operation by friction between the sleeve and the pipe. The system may include ultrasonic flow rate sensors, depth sensors (alternatively referred to as level sensors or fluid level sensors), tilt and roll sensors, temperature sensors and/or other sensors as needed. The system may include cable interconnect for power and communication with a base system.

The sensors may preferably be designed to be conformal with or to couple with materials conformal with the inside surface of the housing (also referred to as sleeve) to avoid disrupting the flow or catching debris. Further, the cable interconnect may be routed within the thickness dimension of the housing to prevent flow disruptions or the catching of debris.

In one embodiment, the housing may be fabricated by machining standard polyvinylchloride (PVC) pipe. In other embodiments the housing may be molded from injectable material, 3D printed, or other manufacturing methods. In one embodiment, the housing may include a chamfered edge at the flow input or output. In further embodiments, the edge may be designed to optimize hydrodynamic performance. In further embodiments, the housing may include metallic spring material to assist in the force pressing against the inside of the pipe to retain the housing in position during operation.

In further embodiments, the housing has sufficient length to establish stable flow conditions over the velocity sensors.

In one embodiment the housing may include installation holes at the top to fit installation pliers for compressing the diameter for installation and removal of the housing. The installation holes may include a large diameter feature to allow easy finding of the holes to insert the installation pliers together with a smaller notch for precise fit to the installation pliers.

In one embodiment, the installation pliers may be snap ring pliers or hose clamp pliers, in particular, long reach pliers.

In one embodiment, the sensors include an ultrasonic velocity sensor comprising at least one transducer, preferably two transducers. The transducers may be tilted in the flow direction, or sleeve cylindrical axis to utilize Doppler velocity detection. The transducers may utilize refraction and may utilize acoustic matching materials to enhance the directivity up or down the flow direction while maintaining a surface conformal to the housing without protrusions into the flow, thus allowing smooth flow without disruption.

The sleeve inner surface, also called the flow surface, which is the surface in contact with the flow may have a lowest point or region. The sensors are preferably located directly below the lowest region and the flow surface rises with distance away from the lowest region such that low flows, even trickle flows, are directed to the region sensed by the sensors. The cylindrical profile of the inner surface forms a low channel along the flow path that leads to the sensor region. In a further variation, the inner surface may increase in level or altitude with lateral distance from the lowest region.

In one variation, the sleeve may have a constant thickness, alternatively the sleeve may have a tapered profile, being thickest at the bottom containing the sensors and tapering to a thinner profile toward the top. The inner surface of the tapered embodiment may have a circular cross section to improve or simplify flow calculations. Alternatively, other cross section profiles may be utilized.

In further variations, the sleeve may have a tapered structure where the taper terminates in the lower half of the pipe and the sleeve mounting may include a compression band and expansion joint. The sleeve inner surface may have a circular cross section profile, or other profile that increases in level continuously with lateral distance from the lowest point to channel the lowest flows across the sensors.

The sleeve sensor system may demonstrate synergistic cooperation to achieve an elastic friction mount, flow stabilization, and embedded sensors without introducing flow disruption from protrusions or intrusions into the flow interior of the cylindrical inner surface.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an isometric view of an exemplary sensor sleeve system in accordance with the present invention.

FIG. 2 illustrates an end view of the system of FIG. 1.

FIG. 3 illustrates a cutout view of the system of FIG. 1 showing greater detail.

FIG. 4a illustrates a section view of the system of FIG. 1 showing the transducers and ultrasonic beam axes.

FIG. 4b and FIG. 4c show further details of the transducer assembly.

FIG. 5 illustrates an end view or cross section view of the system of FIG. 1 showing the holding forces.

FIG. 6 illustrates a view of an exemplary prior art system.

FIG. 7a and FIG. 7b show an alternative exemplary embodiment partial sleeve 701 having a tapered profile occupying less than half of the pipe circumference.

FIG. 8 shows an alternative embodiment of the system of FIG. 1, but modified to have a tapered thickness profile.

### DETAILED DESCRIPTION

The present disclosure describes a sensor sleeve system that may be advantageous in the wastewater, storm water, irrigation, freshwater, or other related water sectors to monitor shallow flow in smaller pipe diameters with minimal obstruction to the flow. One benefit of this invention is to read accurately in very shallow flow without the risk of creating a small blockage in front of the sensor disrupting the readings and often requiring an expensive field visit to clean or “scrub” the debris from the sensor. Current submerged sensors can cause their own obstructions and disturbances in the flow and are limited in how shallow they can measure due to their own dimensions. In a further advantage, the conformal sensor arrangement of the present invention should mitigate premature sensor failure due to impact damage at faster flow installations, as may occur when the sensor is protruding into the flow beyond the cylindrical inner surface of the sleeve.

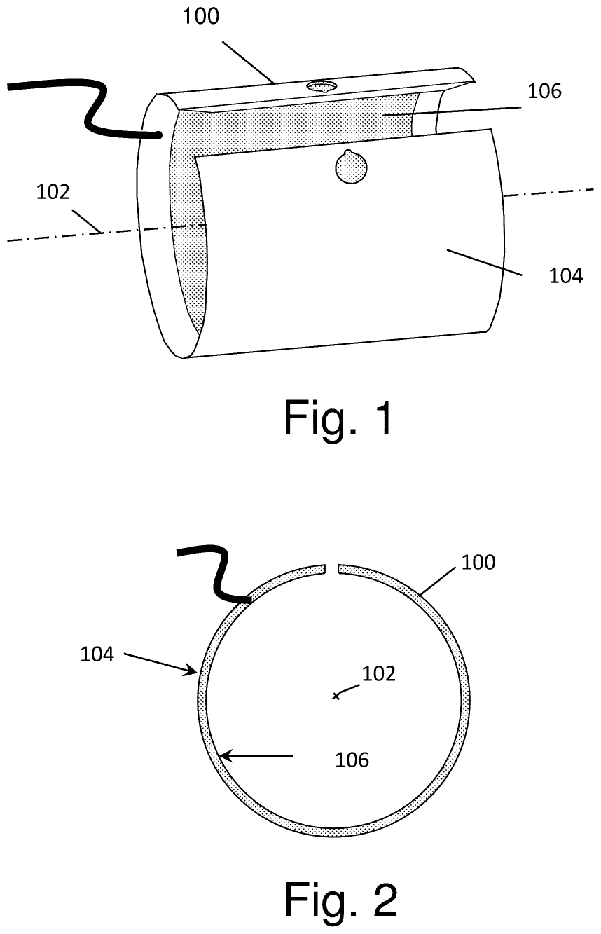

FIG. 1 shows an insertion sleeve system 100 with integrated depth and velocity transducers designed to fit within a standard pipe diameter using long reach pliers to compress the diameter of the sleeve and allow insertion into a pipe. In one embodiment, the sleeve may be configured to be compressed by long reach internal snap ring pliers available commercially. The sleeve forms an interrupted cylindrical shape with an outside surface 104 conforming to the inside surface of a pipe when installed. A cylindrical axis 102 is shown for the outside surface of the sleeve as installed, which would be the same axis as the axis of the pipe. (Pipe not shown.) Also shown is an inside surface 106 of the sleeve to be in contact with the flow.

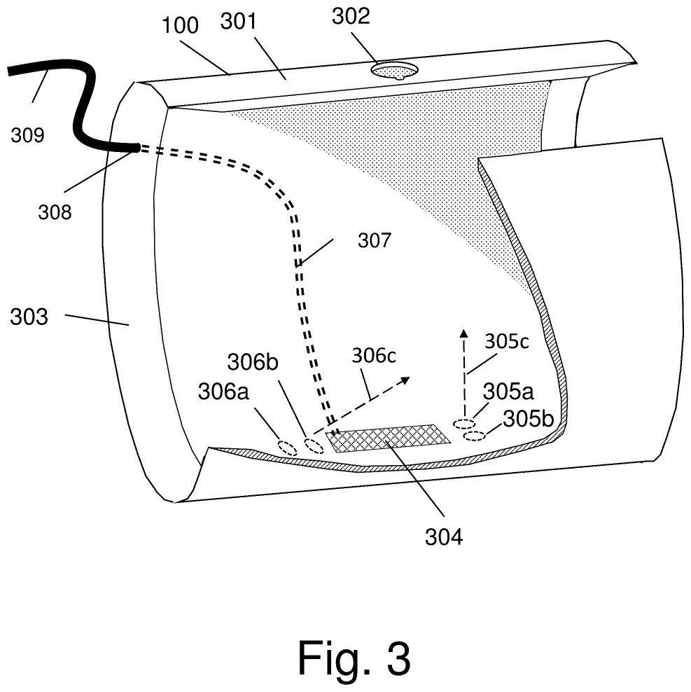

FIG. 2 shows the sleeve sensor system 100 after the insertion tool is removed, leaving a minimally intrusive sensor. As an Area Velocity (AV) sensor, measurement accuracy will benefit from the circular cross-section from which the wetted area will be computed. The system uses outward pressure from the sleeve to secure the sleeve system within the pipe using friction on the pipe. The system may provide more friction on the pipe than typical stainless steel band installations. The cylindrical axis 102 is shown perpendicular to the plane of the drawing. It may be observed from FIG. 1 and FIG. 2 that the inner surface 106 of the sleeve 100 forms a cylindrical surface interrupted only by the gap interruption at the top. No protrusions for sensors or mounting structures extend beyond the cylindrical inner surface envelope into the interior flow region of the sleeve.

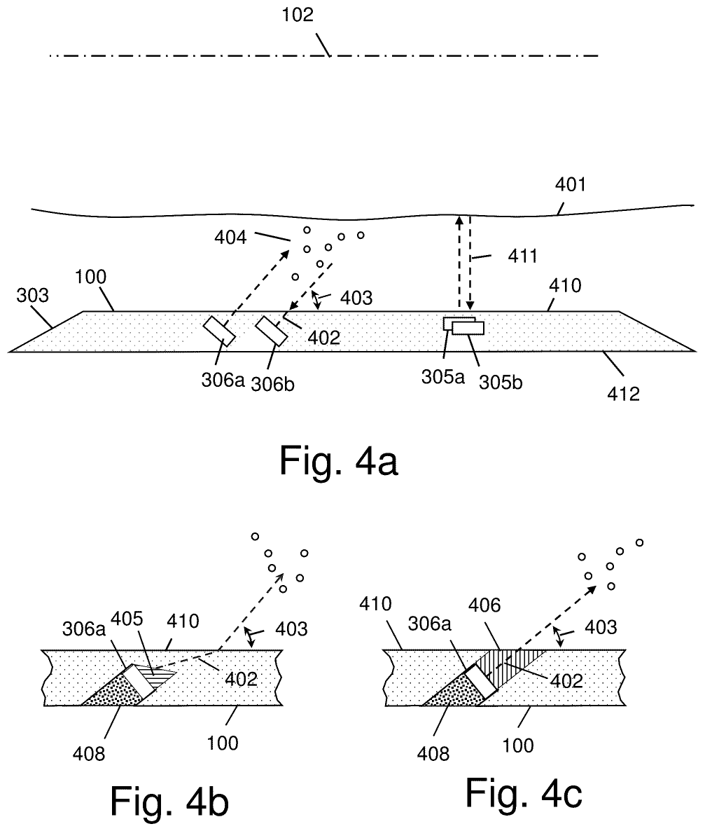

FIG. 3 shows an exemplary sensor sleeve system 100 comprising a plastic sleeve 301 with a 0.375″ (9.5 mm) nominal thickness with notched holes 302 to accommodate a tool (tool not shown) to compress the sensor housing for insertion or removal from a pipe (pipe not shown). The notched holes 302 are provided on each side of the gap at the top of the sleeve. Each hole 302 includes a large opening for ease in finding the hole with the tool when installed in the pipe where visibility is limited. A small notch is provided for more secure fit to the tool. An exemplary tool may be found in the market as a snap ring plier, preferably a long reach snap ring pliers. For example, Lang Tools® extra large snap ring pliers 1489, 26 inch long. FIG. 1 and FIG. 3 show an exemplary opening comprising a large diameter hole having a notch in the side near the gap in the sleeve. An exemplary diameter may be from one to five centimeters, preferably from 1.5 to 3 centimeters, with a notch from three to five millimeters, preferably to match with a point of the installation tool.

The leading and trailing edges of the sleeve may include a tapered end 303 to minimize disruption to the flow and reduce the likelihood of snagging debris. The taper may be preferably from ten to 45 degrees, for example 15 degrees relative to the center axis 102 of the sleeve. Alternatively, the leading or trailing edges may include hydrodynamic curves to minimize the disturbance to the flow. The sleeve may further include an extended region between the taper and the sensors to further stabilize the flow for the sensor measurement. The extended region may be, for example, two inches (5 cm), preferably between 1 cm and 20 cm.

The sleeve may include transducers for sensing level and velocity. The taper should terminate before the transducers. The sleeve may have an embedded printed circuit board assembly (PCBA) 304 that may select the proper transducers and communicate with a data logger (not shown). The PCBA may also contain support for a pressure transducer, temperature sensor, capacitance sensor, and/or an accelerometer for detection of angular rotation and/or angle of incline. A pair of ultrasonic transducers 305a and 305b are embedded in the bottom of the sleeve and aimed vertically to measure the level (depth) of the flow. Arrow 305c indicates a substantially vertical beam for 305a and 305b. An additional pair of ultrasonic transducers 306a and 306b are embedded in the bottom of the sleeve preferably at an angle, thus enabling the measurement of the velocity in very shallow flows.

In one embodiment, the transducers and/or the PCBA may be removable in a module mountable in a slot or cavity in the sleeve. The module may be fed by a cable 307 carrying power and communications. The cable may have an internal part 307 and an external part 309. The cable may have a waterproof connector at any desired point. In a further advantage, the cable 307 may be integrated into the sleeve to eliminate disruption of the flow and eliminate debris collection.

Note also that the cable entry point 308 to the sleeve may be in the upper half and not at the very top of the sleeve. Keeping the cable entry to the upper half keeps the cable out of most of the flow. Avoiding the very top prevents interference with the mounting pliers or other tool facilitating mounting and removal of the sleeve. An exemplary desirable location may be greater than 30 degrees from top, or about the 10 o'clock or 2 o'clock rotation angle (60 degrees) from the top (12 o'clock). Thus, the entry point 308 should preferably be between the nine o'clock and eleven o'clock angle, or one o'clock and three o'clock on the other side. Note also that the cable 307, as shown, runs parallel to the circumference of the sleeve especially in the lower half for minimum effect (weakening) on the bending forces in the sleeve.

A further advantage of the sleeve configuration is that the level of the top of the flow (depth) can be measured in flows as shallow as 0.25 inch (6.4 mm). In shallow flow, the velocity is measured in the proximity of the level measurement (i.e., withing the length of the same sleeve) to greatly improve the accuracy of the flow computation. Note that the flow steps up to the level of the inside of the sleeve and then establishes stable flow before flowing across the sensors. A further feature is that the sleeve extends up the sides of the pipe so that all of the flow contributes to the sampled flow at the sensors and the full flow may be calculated from the sensor data. Low flows do not bypass the sensor entirely. The flow must step up slightly by the thickness of the sleeve, and then is channeled to the bottom of the cylindrical sleeve to flow directly over the sensor. Thus, even the slightest flow, even a trickle flow may be directed to the sensor.

Further note that the lowest part of the flow is directly above the transducers and the sleeve rises to the side of the sensors continuously in accordance with the diameter of the sleeve and pipe. Thus, the sleeve presents a smooth regular, preferably cylindrical flow interior without protrusions for sensors or mounting hardware, enabling accurate calculation of the flow volume based on velocity and depth measurements.

In a further option (not shown), rubber seals or caulking may be used to block potential flow under the sleeve, however, in practice, silt and similar material will typically settle under the sleeve and further measures may not be necessary.

A prototype was tested in a very low flow test pipe that was created specifically to validate this concept. This prototype was measuring flow down to 0.25 inches (6.4 mm) of depth at velocity down to 0.15 feet per second (0.05 m/sec).

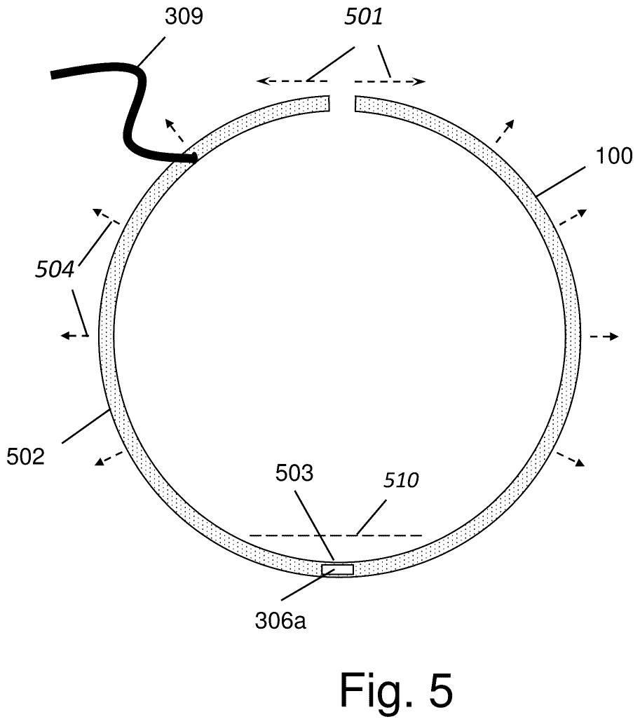

FIG. 4a shows a section view of the transducers in the bottom of the sleeve 100. The first pair of ultrasonic transducers 305a, and 305b are mounted either tandem or side-by-side within the thickness at the bottom of the sleeve and are aimed vertically toward the surface of the flow 401. An ultrasonic wave is transmitted from the first transducer 305a. A reflection 411 from the surface 401 is received by the second embedded ultrasonic transducer 305b adjacent to the first 305a and is processed to compute the level of the flow. In another embodiment, the level transducers 305a and 305b may be aimed or tilted towards each other to facilitate measurement in shallow water. A preferred tilt angle may be from three to ten degrees, for example five degrees, or another angle as needed.

A second pair of ultrasonic transducers 306a and 306b may be directed to measurement of flow velocity. The transducers may be 0.25 inch (6.4 mm) in diameter and 0.08 inch (2 mm) thickness or similar size and operate at 900 kHz or other frequencies above 600 kHz. The transducers may be mounted in either tandem or side-by-side positions. In an optional embodiment, the second pair may be aimed at angle 402 and minimize acoustic refraction to result in beam axis angle 403 relative to the top surface 410 (inside surface 410) of the sleeve 100 to direct the beam at a practical angle into the flow without the transducers protruding into the flow. The transducers may be mounted within the thickness of the sleeve resulting in a smooth inner surface of the sleeve, and therefore avoid snagging debris or failing due to impacts from debris in high velocity flow. The sensors and transducers may transmit through the surface 410 of the sleeve. The surface being flush with the sleeve without protruding into the flow and continuous with the inside surface of the sleeve. Further, the transducers may be at the bottom of the sleeve embedded in the sleeve below the top surface at the lowest region of the top surface such that the slightest trickle flow is directed across the transducers. The transducers may be embedded in the sleeve, i.e., mounted between the inner surface 410 of the sleeve in contact with the flow and the outer surface 412 of the sleeve in contact with the pipe inner wall. The sleeve cylindrical center axis is shown, which may be parallel to the inner surface 410 and the outer surface 412. The beam axis from a first transducer 306a is directed into the flow in which moving particles 404 may reflect a Doppler shifted signal. The reflection may be received by a second embedded ultrasonic transducer 306b and processed using an FFT (Fast Fourier Transform) and/or other processing to compute the velocity of the fluid.

FIG. 4b is an exemplary embodiment using an acoustic matching layer. The acoustic matching layer is provided to help direct the acoustic beam at a lower angle (more parallel to the sleeve surface and water flow direction. The lower angle is to improve the response to the particle horizontal velocity vector. FIG. 4b shows acoustic transducer 306a coupled through a first matching layer 405 having a wedge-shaped thickness or forming a triangular prism. The same may be applied to transducer 306b. Further, the first matching layer preferably has an acoustic impedance similar to the acoustic impedance of water. Exemplary materials may include polyurethane, Araldite® epoxy, Bakelite®, or materials with similar acoustic properties. The result is a beam direction at a lower angle than the initial angle normal (perpendicular) to the face of the transducer 306a. The beam is then deflected slightly upward at the sleeve to water interface 410 due to the plastic and water acoustic properties. The resulting beam is, however, lower than the beam angle would be without the matching layer. The transducers may include a backing material 408 to enhance acoustic properties. Exemplary materials may include epoxy or epoxy with embedded tungsten powder.

FIG. 4c illustrates a further exemplary embodiment using an acoustic matching section. Referring to FIG. 4c, transducer 306a (also applied to 306b) is embedded in sleeve 100 and back filled with a backing material 408. The front side of the transducer 306a is coupled to a second acoustic matching material 406. The second acoustic matching material 406 such as polyurethane, Araldite® (epoxy), Bakelite® (polyoxybenzylmethyleneglycolanhydride), or other material is selected to have an acoustic impedance near the impedance of water (preferably within a factor of two) such that there is little bending of the acoustic beam at the sleeve to water interface 410. The second acoustic matching material 406 is shown forming a cylindrical section similar in diameter as the transducer 306a. The second acoustic matching material is in direct contact with the water and forms directly the sleeve to water interface. In one embodiment, the transducer 306a may be mounted with a beam axis 402 at 45 degrees relative to the sleeve surface, preferably between 30 and 60 degrees (zero degrees being parallel).

Exemplary materials for the backing material 408 may include epoxy with tungsten powder or glass beads or other materials to improve the acoustic properties (e.g., improve the sensitivity and directivity) of the transducers.

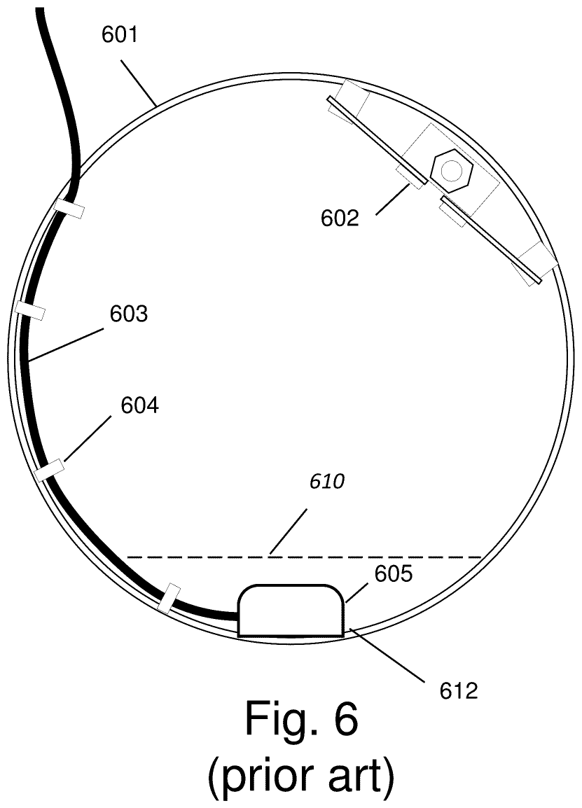

FIG. 5 shows the sensor sleeve as a singular component presented as installed into a pipe. (Pipe not shown.) With tapered edges, the sleeve 100 has a minimal effect on the cross-sectional area of the pipe while having the capability of measuring flow rates down to near zero flow depth 503. The dashed line representing an exemplary minimum measurement flow level 510, typically 0.25 inch (6.4 mm) depth within the length of the sleeve. The suggested minimum measurable flow may be a result of sensor characteristics. The sleeve should be capable of directing even trickle flows across the sensors. The expansion force 504 of the sleeve exerts constant friction 502 against the pipe and does not loosen over time. A typical force 501 between the mounting wrench access holes that is required to squeeze the sleeve to install and/or remove the sleeve may be one kilogram (2.2 lbs) for the exemplary (6 inch (152 mm) or 8 inch (203 mm)) pipe diameters.

In one exemplary embodiment, 6 inch diameter schedule 40 PVC pipe is machined to form the sleeve. The sleeve is used with 6 inch schedule 40 steel pipe, 6.065 inch (154 mm) inside diameter. The PVC pipe inside diameter 6.03 inch (153 mm) and outside diameter 6.625 inch (168 mm.) So, the PVC OD 6.625 inch is squeezed to fit well inside the steel 6.06 inch ID (inside diameter) for insertion and positioning, then released to expand to the steel 6.06 ID with remaining elastic retention compression against the steel pipe inside wall.

The system improves wastewater sensing applications by improved measurement accuracy compared to existing ultrasonic systems because of the ability to measure low flows while minimizing disturbance of the flow. Further, due to the flush configuration, the sensor sleeve is more durable/reliable with respect to impacts from large debris, and decreased likelihood of debris collection.

Alternatively, the PVC sleeve may be installed in PVC pipe. The system appears well adapted for improved performance, in particular, for exemplary 6″ and 8″ pipe installations.

Other pipe sizes may be accommodated as desired. PVC pipe may be heated and formed to adjust size or compression force. Alternatively, custom moldings with custom materials may be used. It may be noted that a particular pipe size may be used to form a sleeve for use in that same pipe size.

An exemplary sleeve length may be 12 inches (30.5 cm). There may be some slight weakening of the spring holding action due to the machining of the sensor area. Such weakening may be compensated by extending the length of the sleeve to include additional length with full thickness material.

The sleeve is shown with the gap at the top or 12 o'clock position and the sensors at the bottom, or 6 o'clock position. Alternatively, the gap may be at some other angle, as desired. The sensors in accordance with the present description would be preferably located at the bottom of the flow 503. Alternatively, other sensor types that observe the top of the flow or any other position may also be used. The exemplary gap may be 1 inch, 2.5 cm wide as installed, wider before installation. The gap may be any dimension as desired. The gap should be less than half of the circumference in order to produce vertical holding force, preferably less than 120 degrees, more preferably less than 60 degrees.

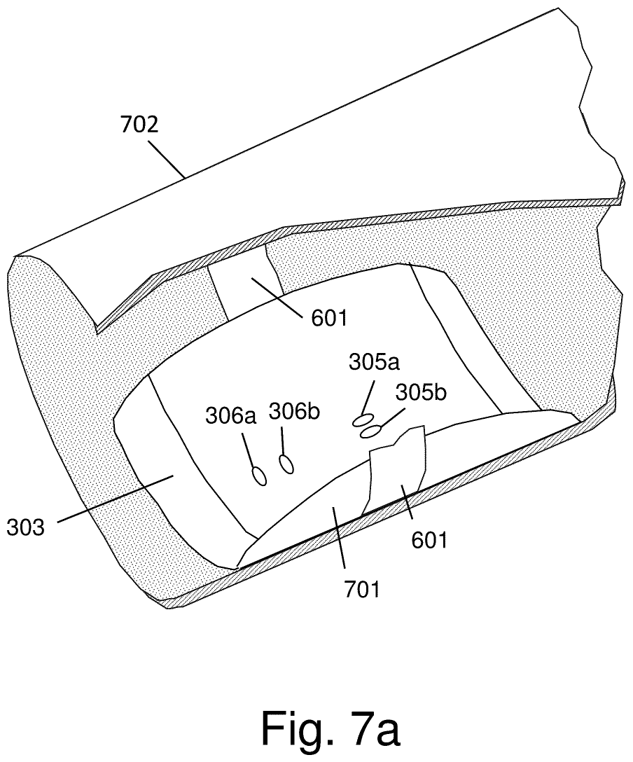

FIG. 6 shows exemplary prior art technology comprising multiple components, including a stainless-steel band 601 and a crank assembly 602 to expand the diameter of the band to secure the band in a pipe. (Pipe not shown). A depth and velocity sensor 605 is mounted directly to the band and is typically positioned at bottom dead center. A cable 603 to power the sensor and retrieve the data is connected using cable ties 604, also attached to the band. There are at least four drawbacks to the prior art. The minimum flow level 610 that can be read is typically above the top of the sensor 605, generally about 1 inch, 2.5 cm of depth. The bottom of the flow 612 flows around the sensor and flows level with the top of the sensor will be completely missed by the sensor. The combination of the band 601, expansion crank 602, sensor 605, and or cable 603 create an obstruction to the cross-sectional flow making the wetted area calculation less accurate and can create a discrepancy between the points in the flow where the depth and velocity are measured. The likelihood of this configuration catching debris or becoming dislodged is greater than for the sleeve. Further, the velocity transducer 605 is exposed to impacts from objects in the flow and can sustain permanent damage.

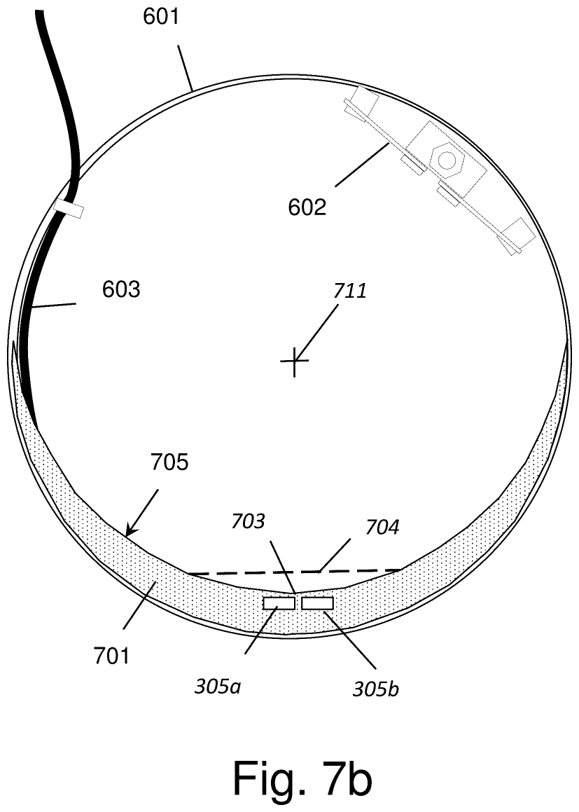

FIG. 7a and FIG. 7b show an alternative embodiment partial sleeve 701 having a tapered circumferential profile occupying less than half of the pipe circumference. The sleeve may occupy more than one eighth, preferably more than one quarter of the pipe inside circumference. The pipe inside circumference is equal to the sleeve and band outside circumference. FIG. 7 shows the partial sleeve 701 with flow direction taper 303, sensors 306a, 306b, 305a, 305b, band 601, and pipe 702. The reduced holding from the reduced circumferential contact of the sleeve with the pipe may benefit from a traditional band and crank mounting as in FIG. 6. The configuration of FIG. 7a and FIG. 7b retains the benefit of the full sleeve in that the flow is channeled to the center above the flow sensors, i.e., flow around the sensors is prevented. Thus, near minimum flow can be sensed.

Referring to FIG. 7b, the partial sleeve 701 is shown attached to the band 601 mounted with crank 602. The sleeve is centered at the bottom of the flow 703 with the sensors mounted below and aligned with the bottom of the flow 703. The cross section of the sleeve 701 tapers laterally in the circumferential dimension such that the lowest point in the flow 703 is above the sensors. The sleeve inside surface rises continuously and smoothly on both sides of the sensors to prevent flow around the sensors and direct minimum flow 704 across the sensors. An exemplary minimum flow surface is shown 704. The top profile 705 may be a circular arc or other arc as desired. Preferably, the top profile 705 has a continuous upward curvature increasing with lateral distance away from the sensors. A sleeve cylindrical axis 711 is shown based on the outer surface of the sleeve 701 and band 601 in contact with the pipe.

In a further embodiment, a steel band 601 may be fabricated using spring steel and fabricated to have an uninstalled diameter greater than the inside pipe diameter. The band may include a gap at the top and notches similar to the sleeve gap and notches 302 and installed using a snap ring plier as described for the sleeve 100.

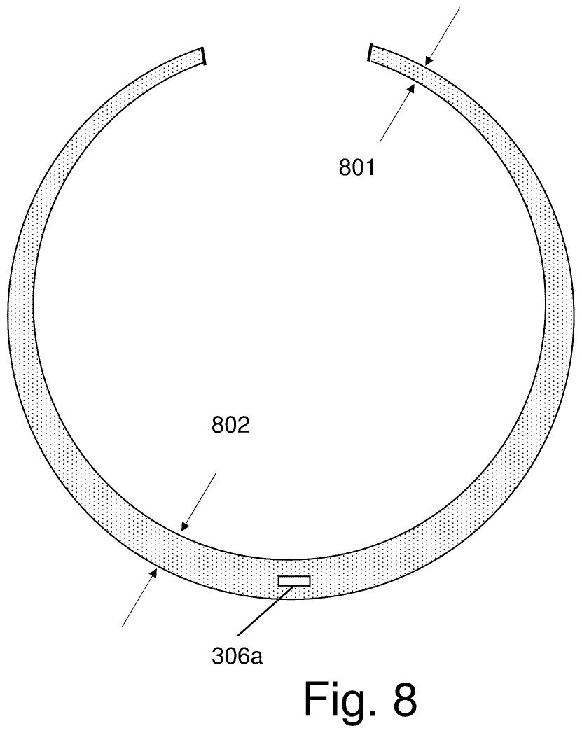

FIG. 8 shows an alternative embodiment of the system of FIG. 3, but modified to have a tapered thickness profile. As shown the upper sleeve wall 801 is dimensionally thinner for less flow restriction at maximum flow while still providing sufficient elastic holding force. The bottom section 802 is thicker to accommodate transducers and electronics. The shape of the inner flow opening should preferably create an eccentric circular pipe opening to facilitate the calculation of wetted area and relate the velocity and depth sensor data to volume flow. Other opening profiles may be used with appropriate compensation in the flow calculations.

Relative terms including bottom, top, side, lateral, center, level and other terms refer to the drawing as depicted and/or to the device as installed in a pipe with the sensors at the gravitational bottom of the pipe where the lowest flow is to be sensed by the sleeve. Level refers to height above the bottom of the sleeve or pipe, depending on context.

While various embodiments of the present invention have been described above, it should be understood that they have been presented by way of example only, and not limitation. Thus, the breadth and scope of the present invention should not be limited by any of the above-described exemplary embodiments but should be defined only in accordance with the following claims and their equivalents.

What is claimed is:

1. A flow measuring system for measuring liquid flow in the inside of a pipe, comprising:
a flow channeling mounting sleeve having an interrupted cylindrical structure for conforming to the inside of a pipe, said cylindrical structure having a gap at the top allowing the flexing of the cylindrical structure for mounting said cylindrical structure within said pipe; said cylindrical structure having an elastic force for causing force against the inside of said pipe sufficient to hold said sleeve in position within said pipe during operation;
said sleeve having a sleeve cylindrical axis based on said cylindrical structure, said sleeve having an inside surface for contact with said flow, said inside surface having a lowest region and said inside surface increasing in level with rotational angle from said lowest region, said rotational angle based on said cylindrical axis, thereby directing low level flows to the lowest region;
said sleeve further comprising at least one flow level sensing transducer for sensing a level of said liquid flow; said flow level sensing transducer sensing through said inside surface at said lowest region.

2. The system of claim 1, further including at least one velocity sensing transducer, said velocity sensing transducer configured to measure flow velocity within said sleeve.

3. The system of claim 2, wherein said flow velocity sensing transducer is tilted relative to said sleeve cylindrical axis to enhance beam sensitivity parallel to the flow to enable Doppler detection of flow velocity.

4. The system of claim 3, wherein said velocity sensing transducer tilt angle is between 30 and 60 degrees relative to said sleeve cylindrical axis.

5. The system of claim 4, wherein the velocity sensing transducer is coupled through an acoustic matching material to increase a lateral beam direction component to enhance Doppler detection of velocity.

6. The system of claim 5, wherein a lowest region of said inside surface of said sleeve is vertically over the level sensing transducer; thereby preventing low flows from flowing around the level sensing transducer.

7. The system of claim 6, wherein a cross section of the inside surface follows a circular arc for at least 180 degrees around said sleeve cylindrical axis.

8. The system of claim 1, wherein said sleeve inside surface conforming to a cylindrical envelope, wherein said inside surface is free of protrusions into the interior of said cylindrical envelope, thereby allowing undisturbed flow within said sleeve.

9. The system of claim 1, wherein the sleeve has an entry edge and said entry edge is tapered for flow transition upon entry of said flow to said sleeve.

10. The system of claim 9, further including an extended entry section of the sleeve between the sleeve entry edge and said first transducer, wherein said extended entry section is at least ten centimeters in length.

11. The system of claim 1, wherein the gap at the top is less than 5 centimeters wide when the sleeve is installed in said pipe.

12. The system of claim 1, wherein the gap at the top is less than 120 degrees based on the sleeve cylindrical axis.

13. The system of claim 1, wherein said sleeve forming at least two holes, one of said holes on each side of said gap at the top of the sleeve for access by a tool to compress the sleeve for installation in said pipe.

14. The system of claim 1, further including a second level transducer, wherein said first level transducer and said second level transducer are tilted toward one another at an angle of three to ten degrees.

15. The system of claim 1 further including a connecting cable, wherein said connecting cable enters the sleeve in the top half of the sleeve and is embedded in the sleeve for at least the bottom half of the sleeve.

16. The system of claim 1, wherein said sleeve has a tapering thickness; the thickness being greatest at the bottom and thinning toward the top, the sleeve having a gap at the top less than 120 degrees around said sleeve cylindrical axis.

17. The system of claim 16, wherein the inside surface has a circular arc cross section profile for at least 240 degrees based on said sleeve cylindrical axis.

18. A flow measuring system for measuring liquid flow in a pipe, comprising:
a flow channeling mounting sleeve having a tapered structure for conforming to the inside of a pipe, said tapered structure occupying less than half of the circumference of a cross section profile of the pipe;
said system mounted to a compression band conformal to the inside of said pipe and compressed to the inside of the pipe using an adjustable expansion joint;
said sleeve having a sleeve cylindrical axis based on said compression band,
said sleeve having an inside surface for contact with said flow, said inside surface having a lowest region and said inside surface increasing in level with rotational angle from said lowest region, said rotational angle based on said cylindrical axis, thereby directing low level flows to the lowest region;
said sleeve further comprising at least one flow level sensing transducer for sensing a level of said liquid flow; said flow level sensing transducer sensing through said inside surface at said lowest region.

19. The system of claim 18, wherein the inside surface has a circular arc cross section profile for at least 120 degrees relative to said sleeve cylindrical axis.

20. The system of claim 18, wherein said inside surface of said sleeve increases in level continuously laterally from said lowest region for at least sixty degrees relative to said sleeve cylindrical axis.
